(19) United States
(12) Patent Application Publication
(10) Pub. No.: US 2008/0042538 A1
(43) Pub. Date: Feb. 21, 2008

(54) Metallic Concave Reflection Mirror, Light Source and Light Source Apparatus Using the Same, and Lighting Circuit Thereof

(75) Inventors: Toshitaka Fujii, Hyogo (JP); Atsuji Nakagawa, Hyogo (JP); Tomihiko Ikeda, Hyogo (JP); Hisao Furukawa, Hyogo (JP)

Correspondence Address: LUCAS & MERCANTI, LLP, 475 PARK AVENUE SOUTH, 15TH FLOOR, NEW YORK, NY, 10016, US

(73) Assignee: PHOENIX ELECTRIC CO., LTD., HYOGO (JP)

(21) Appl. No.: 11/572,463

(22) PCT Filed: Sep. 14, 2004
(86) PCT No.: PCT/JP04/13344

§ 371 Date: Jan. 22, 2007

(51) Int. Cl. H01J 5/16

(52) U.S. Cl. 313/113

(57) ABSTRACT

This invention makes it possible to use a concave reflection mirror using metal in at least a concave reflective portion thereof for discharge lamps. The concave reflection mirror is characterized by including: a metallic concave reflective portion; and a neck portion for receiving therein a high voltage side seal portion of a high-pressure discharge lamp to be continuously applied with a d.c. voltage of 1000 V to 4000 V during an ignition phase, the neck portion protruding rearward from a central portion of the metallic concave reflective portion and being formed partially of an insulating member or entirely of an insulating material. The concave reflection mirror can have a concave reflective surface with improved curved surface precision thereby making it possible to reduce variations in brightness, use a multi-layered deposited film having a low heat resistance, and reduce the required cost considerably.

### TECHNICAL FIELD

The present invention relates to a concave reflection mirror to be used as fitted on a discharge lamp, at least a concave reflective portion of which mirror is formed of metal, a light source apparatus using the concave reflection mirror, and a lighting circuit thereof, which are for use in information equipment, such as a liquid crystal projector, or video equipment, such as a projection television.

### BACKGROUND ART

FIG. 2 shows a conventional light source (B) having a glass concave reflection mirror (2′) fitted on a high-pressure discharge lamp (10) for use in a liquid crystal projector. The high-pressure discharge lamp (10) is positioned with its optical axis substantially coinciding with that of the glass concave reflection mirror (2′) so as to generate a bundle of parallel rays or converging rays forwardly. Glass has been solely used as the material of such a concave reflection mirror (2′).

Metal has not been able to be used for the concave reflection mirror (2′) to be fitted on the high-pressure discharge lamp (10) instead of glass because a pulse voltage as high as 15 kV would have to be continuously applied across electrodes (12) and (13) for dielectric breakdown therebetween during an ignition phase of the high-pressure discharge lamp (10). Specifically, continuous application of a high pulse voltage of 15 kV would allow abnormal discharge to occur between an external lead pin (16) exposed from a high voltage side seal portion (18) of the high-pressure discharge lamp (10) and a metal portion located adjacent the external lead pin (16) (which corresponds to the neck portion of the concave reflection mirror when a metallic concave reflection mirror is used), resulting in a lighting failure of the high-pressure discharge lamp (10). In some cases, such abnormal discharge is allowed to occur between an external lead pin (17) located on the low voltage side or an auxiliary lead (20) associated therewith and a metal portion located adjacent thereto.

A material for such a glass concave reflection mirror (2′) is selected to meet a maximum mirror temperature during use. If the power consumption is relatively low (not more than 250 W), borosilicate glass having a heat resistance to about 400° C. is used. If the power consumption is relatively high (not less than 200 W), crystallized glass having a heat resistance to about 500° C. is used.

The concave reflection mirror (2′) has a concave reflective surface (2c′) coated with a multi-layered (about 30 layers) deposited film (2d′) comprising titanium oxide (TiO₂) and silicon oxide (SiO₂). The reflective surface (2c′) reflects visible rays only and permits infrared rays to pass therethrough toward behind. This multi-layered deposited film (2d′) has such an excellent heat-resistant property as to overcome the difference in thermal expansion between a glass substratum of a concave reflective portion (2a′) and the multi-layered deposited film (2d′) which occurs at a temperature during lighting, hence, prevent the multi-layered deposited film (2d′) from being peeled off. For this reason, the adhesion between the two is considered as having no practical problem. However, the concave reflection mirror (2′) formed of glass has possible problems as follows.

(a) The concave reflection mirror (2′) has a relatively complicated shape which calls for a high precision, particularly, at the concave reflective surface (2c′). For this reason, the manufacture of the reflection mirror (2′) is relatively costly. In addition, if the wattage of the high-pressure discharge lamp (10) is high and, hence, the temperature of the lamp (10) during lighting is high, use has to be made of crystallized glass having an excellent heat-resistant property. Since such crystallized glass is expensive, the cost of material becomes relatively high.

(b) The glass concave reflection mirror (2′) is poor in thermal conductivity and, hence, the multi-layered deposited film (2d′) to be formed over the concave reflective surface (2c′) (for reflecting visible rays and permitting infrared rays to pass therethrough) is required to have such an excellent heat-resistant property as described above because the whole of the mirror (2′) is heated to an high temperature during lighting. The multi-layered deposited film (2d′) comprises a large number of stacked film layers as described above and is deposited at a high temperature in the vapor deposition oven. For this reason, a prolonged time is required for vacuum drawing in the evaporator oven, thus resulting in a relatively high processing cost.

(c) The light source (B) is required to prevent fragments of the high-pressure discharge lamp (10) from scattering to the surroundings upon explosion of the lamp (10). Since glass essentially has a low impact resistance, the concave reflection mirror (2′) is likely to be broken when such fragments of the high-pressure discharge lamp (10) impinge upon the mirror (2′) due to explosion of the lamp (10). Various remedies which have been taken for preventing the concave reflection mirror (2′) from being mechanically broken upon explosion of the high-pressure discharge lamp (10) include: thickening the glass substratum; and coating the outer surface of the concave reflection mirror (2′) with a fluororesin. The former remedy involves a problem of limitations on molding, while the latter has a problem associated with the cost, such as a considerably high cost of fluororesin coating.

(d) Since a pulse voltage as high as 15 kV is needed as the dielectric breakdown voltage as described above, an insulation distance (S2) of at least about 15 mm is needed between the exposed portion of the high voltage side external lead pin (16) extending from the high voltage side seal portion (18) of the high-pressure discharge lamp (10) and a metal portion (7) around the exposed portion of the external lead pin (16). (The metal portion (7) is a metal portion of a lamp house housing the light source (1) comprising the high-pressure discharge lamp (10) fitted with the concave reflection mirror (2′) using a glass substratum.) Such a required insulation distance will greatly hinder a reduction in size and an increase in integration density of a projector. Additionally, an insulation distance (S1) is also needed between the low voltage side external lead pin (17) extending outwardly from a low voltage side seal portion (19) and the high voltage side external lead pin (16). For this reason, the low voltage side lead pin (17) has to be connected to a metal electrode (22) fitted on the concave reflective portion (2a′) via the auxiliary lead (20).

(e) The curved surface precision of the concave reflective surface (2c′) of the concave reflection mirror (2′) largely influences the brightness of the light source. Variations in curved surface precision are essential to the concave reflection mirror (2′) using glass. For this reason, it is difficult for molding of the concave reflection glass mirror (2′) to be controlled in order to meet the curved surface precision requirements. Stated otherwise, as long as the glass concave reflection glass mirror (2′) is used, there is a problem essential to the material used that variations in brightness are unavoidable.

(f) A conventional lighting circuit (b) has a configuration as shown in FIG. 2. With such a circuit, a high pulse voltage of 15 kV is continuously applied during the ignition phase as described above. Therefore, there has been no choice but using glass as the material of the concave reflection mirror (2′). Brief description will be made of the conventional lighting circuit (b).

During the discharge lamp ignition phase (or reignition phase after turning-off of the lamp), an ignition voltage, which is produced by superimposition of a high pulse voltage (12 to 25 kV having a pulse width of about 0.1 msec) a long thin shaped and having a pulse interval of several 10 Hz which is generated by an igniter (4′) on the output voltage (about 300 to about 350 V) of a ballast (6), is applied between the electrodes (12) and (13) of the discharge lamp (10).

Applying of such a high pulse voltage for several times causes dielectric breakdown between the electrodes (12) and (13), thus allowing the cathode (13) to emit electrons to the anode (12) and forming a narrow discharge path. In this way, discharge starts. Subsequently, as current with a proper voltage is applied, the discharge state shifts to arc discharge through glow discharge which is a transitive discharge state. Because mercury within an arc tube (11a) remains unevaporated during the initial period of arc discharge just after transition, the voltage between the electrodes (12) and (13) lowers to about 15 V for example. Thereafter, as mercury evaporates with rising temperature, the voltage rises to about 80 V, thus realizing steady-state lighting.

Additionally, a problem has been pointed out that explosion of the discharge lamp (10), if it occurs, causes mercury within the discharge lamp (10) to be scattered to the around thereby to contaminate the surroundings, though it is a subordinate problem.

A number of light sources employing such a glass reflector are described in literature documents including U.S. Pat. No. 6,211,616.

Patent document 1: U.S. Pat. No. 6,211,616

### BRIEF SUMMARY OF THE INVENTION

A first object of the present invention is to provide a concave reflection mirror for discharge lamps, at least the concave reflective portion of which comprises metal. A second object is to improve the curved surface precision of the concave reflective surface by the use of metal thereby to reduce variations in brightness. A third object is to attain a reduction in size and an increase in integration density of an overall light source apparatus by the use of such a concave reflection mirror. A subordinate object is to minimize scattering of mercury to the surroundings from a discharge lamp in case of explosion of the discharge lamp.

A first aspect in accordance with the present invention, a concave reflection mirror (2) is comprising: a metallic concave reflective portion (2a); and a neck portion (2b) for receiving therein a seal portion (18) of a high-pressure discharge lamp (10) to be continuously applied a d.c. voltage of 1000 V to 4000 V during an ignition phase, the neck portion (2b) protruding rearwardly from a central portion of the metallic concave reflective portion (2a) and being formed partially of an insulating member (3) or entirely of an insulating material.

All or at least the concave reflective portion (2a) of the concave reflection mirror (2) is formed from metal. This arrangement allows the surface precision of a concave reflective surface (2c) to be remarkably improved by machining, such as polishing, on the concave reflective surface (2c) after molding, thereby providing high-precision concave reflection mirror (2) free from variations in brightness. In addition, the concave reflection mirror (2), which comprises metal, is excellent in heat radiation property and hence is capable of using a multi-layered deposited film (2d) having an inferior heat-resistant property on the concave reflective surface (2c). Accordingly, the cost of manufacturing the concave reflection mirror (2) can be reduced considerably.

According to the present invention, the all or at least the concave reflective portion (2a) of the concave reflection mirror (2) is formed from metal instead of glass used conventionally. The present invention employs a starting method using a substantially direct current voltage of 1 to 4 kV for causing dielectric breakdown during the lamp ignition phase instead of a high pulse voltage of about 15 kV used conventionally. This method allows an electrical insulation distance (S3), (S4) or (S5) between an exposed portion of an external lead pin (16) or (17) and a metal portion located adjacent thereto to be shortened. (Such metal portions include a metal portion (7) of a lamp house, the metallic neck portion (2b) of the concave reflection mirror (2), and an auxiliary lead (20) extending through the neck portion (2b) on the low voltage side as shown in FIG. 1.)

Specifically, each of such insulation distances can be shortened to about 2 to 6 mm, which is far smaller than in the conventional light source apparatus, in accordance with the d.c. voltage of 1 to 4 kV to be applied during the ignition phase. In FIG. 1, such insulation distances include: insulation distance (S3) between the exposed portion of the external lead pin (16) extending outwardly from the seal portion (18) fitted in the neck portion (2b) and the metal portion (7) of the lamp house; insulation distance (S4) between the exposed portion of the external lead pin (16) and the auxiliary lead (20); insulation distance (S5) between a portion of the auxiliary lead (20) extending through the neck portion (2b) and the neck portion (2b); and insulation distances (S13) and (S14) between the exposed portion of the external lead pin (17) extending outwardly from a seal portion (19) located centrally of the concave reflective portion (2a) or an exposed portion of the auxiliary lead (20) associated with the external lead pin (17) and the inner and outer surfaces of the concave reflective portion (2a) formed from metal (see FIG. 3). As a result, the capacity of the lamp house can be reduced and, hence, the overall light source apparatus (A) can be rendered compact and have a higher integration density.

In many cases, the external lead pin (16) extending outwardly from the seal portion (18) fitted in the neck portion (2b) is located on the high voltage side to be applied with a high voltage during the ignition phase. In some cases, however, the external lead pin (17) extending outwardly from the seal portion (19) located centrally of the concave reflective portion (17) is located on the high voltage side. Though the side on which the seal portion (18) is located is described as the high voltage side, the present invention is not limited to this arrangement.

A second aspect in accordance with the present invention, a concave reflection mirror (2) is comprising: a metallic concave reflective portion (2a); and a neck portion (2b) for receiving therein a seal portion (18) of a high-pressure discharge lamp (10), the neck portion (18) protruding rearward from a central portion of the metallic concave reflective portion (2a) and being formed partially of an insulating member (3) or entirely of an insulating material, wherein the metallic concave reflective portion (2a) has a concave reflective surface (2c) with an opening portion provides an amalgam producing substance which is combined with mercury.

The opening portion (2f) of the concave reflective surface (2c), particularly, a range of, for example, 5 to 10 mm from the open end is a dead zone that is substantially not utilized in reflection of light rays emitted from the high-pressure discharge lamp (10). The provision of the amalgam producing substance in the opening portion (2f) as the dead zone (by plating for example) enables a portion of high-temperature mercury vapor to react with the amalgam producing substance to produce a mercury amalgam in case of explosion of the high-pressure discharge lamp (10). Such a mercury amalgam remains as deposited on the opening portion (2f). As a result, the amount of mercury scattered to the outside can be reduced.

A third aspect in accordance with the present invention, a concave reflection mirror is characterized in that the opening portion (2f) of the metallic concave reflective portion (2a) has a cut-out portion (2g) over which a mesh plate (61) formed from the amalgam producing substance or bearing the amalgam producing substance deposited thereon extends. Examples of such amalgam producing substances include zinc, tin, silver and like substances. The front opening of the metallic concave reflective portion (2a) may be closed with a transparent plate (5) or left open without the provision of the transparent plate (5). This holds true for the concave reflection mirror according to claim 2.

A fourth aspect in accordance with the present invention, the concave reflection mirror is characterized in that the metallic concave reflective portion has a metal portion having a thermal conductivity of not less than 50 W/m·K. The glass material, which has been conventionally used for concave reflection mirrors, has a thermal conductivity as low as about 1.0 W/m·K and hence cannot be expected to exhibit a certain level of heat radiation effect as described above. For this reason, the conventional concave reflection mirror (2′) is heated to a very high temperature during lighting of the high-pressure discharge lamp. If the power consumption of the high-pressure discharge lamp (10) is a rated power of 200 W, temperature of the concave reflective portion (2a′) reaches about 500° C. for example. Therefore, expensive crystallized glass having a heat resistance up to about 500° C. need be used.

In contrast, the use of a metal having a thermal conductivity of not less than 50 W/m·K for the metal portion of the concave reflection mirror (2) allows the temperature of the concave reflective portion (2a) to lower considerably by virtue of a high heat radiation. In the case of the power of 200 W, the overall concave reflection mirror (2) or for at least the concave reflective portion (2a) of aluminum makes it possible to lower the temperature of the mirror to about 300° C. Incidentally, aluminum, iron and copper have their respective thermal conductivities of 233, 56 and 381 (in units of W/m·K).

A fifth aspect in accordance with the present invention, the concave reflection mirror is characterized in that the concave reflective surface (2c) of the concave reflective portion (2a) is formed with a multi-layered deposited film (2d) comprising magnesium fluoride and zinc sulfide. In the case of the conventional concave reflection mirror (2′) using a glass material, the multi-layered deposited film (2d′) having a high heat resistance, which consists of about 30 layers and comprises titanium oxide (TiO₂) and silicon oxide (SiO₂), is formed on the concave reflective surface (2c′) of the concave reflection mirror (2′) as described above.

In the case of the concave reflection mirror (2) using metal for at least the concave reflective portion (2a), the rise in the temperature of the mirror is limited to a significantly low temperature by the heat radiation effect of the concave reflective portion (2a) and, as a result, the multi-layered deposited film (2d) comprising magnesium fluoride (MgF₂) and zinc sulfide (ZnS) can be used. Though this multi-layered deposited film (2d) is inferior in heat-resistant property to the aforementioned multi-layered deposited film (2d′) comprising titanium oxide (TiO₂) and silicon oxide (SiO₂), the multi-layered deposited film (2d) needs to consist of about 22 layers, the number of which is smaller than that of the layers forming the multi-layered deposited film (2d′). Moreover, the multi-layered deposited film (2d) can be deposited at a lower temperature of the evaporator oven than the multi-layered deposited film (2d′) comprising titanium oxide (TiO₂) and silicon oxide (SiO₂) and, hence, it takes a shorter time for vacuum to be drawn, which makes it possible to reduce the cost considerably.

A sixth aspect in accordance with the present invention, the concave reflection mirror is characterized in that the concave reflective portion (2a) has a metallic concave reflective substratum surface (2a1) covered with a heat ray absorptive film (2d1) over which a multi-layered film (2d) is formed as a visible-rays reflective film. With the provision of the heat ray absorptive film (2d1) between the concave reflective substratum surface (2a1) of the concave reflective portion (2a) and the multi-layered deposited film (2d) as the visible ray reflective film, visible rays outgoing from the high-pressure discharge lamp (10) toward the concave reflective surface (2c) are reflected forwardly of the mirror by the multi-layered deposited film (2d), while infrared rays pass through the multi-layered deposited film (2d) toward the substratum surface (2a1) of the concave reflective portion (2a) located behind without reflection.

With no provision of the heat ray absorptive film (2d1) between the metallic substratum surface (2a1) of the concave reflective portion (2a) and the multi-layered deposited film (2d), infrared rays having passed through the multi-layered deposited film (2d) are reflected directly by the metallic substratum surface (2a1) of the concave reflective portion (2a) to heat the irradiated surface in front of the substratum surface (2a1), unlike the glass concave reflection mirror (2′) With the provision of the heat ray absorptive film (2d1) behind the multi-layered deposited film (2d), however, a considerably large part of the infrared rays having passed through the multi-layered deposited film (2d) is absorbed by the heat ray absorptive film (2d1), so that the reflected part of the infrared rays is minimized. As a result, even with the concave reflection mirror (2) using metal for at least the concave reflective portion (2a) thereof, an undesired rise in the temperature of the irradiated surface is avoidable. Heat absorbed by the heat ray absorptive film (2d1) is radiated into the surroundings through the metallic concave reflective portion (2a).

A seventh aspect in accordance with the present invention, the concave reflection mirror is characterized in that the concave reflective portion (2a) of the concave reflection mirror (2) comprises iron or stainless steel and a multi-layered deposited film is formed over a metallic concave reflective substratum surface (2a1) having been subjected to polishing and a subsequent oxidizing treatment. The resulting black-colored iron oxide film or oxidized stainless steel film is capable of absorbing infrared rays and, hence, the concave reflection mirror is capable of efficiently reflecting visible rays only. The method has an advantage over the embodiment of claim 6 that the heat ray absorptive film, which is formed with poor precision, can be eliminated. Moreover, the reflection mirror comprising metal exercises the effect of suppressing heat generation of the lamp by conduction of heat generated by infrared rays absorbed. After turning-off of the lamp, in particular, the metallic concave reflection mirror according to this embodiment exhibits a higher cooling rate than the glass reflection mirror and, therefore, enjoys the effect that the reignition time is shortened with respect to equal ignition voltage.

A eighth aspect in accordance with the present invention, the concave reflection mirror is comprising: a metallic concave reflective portion (2a); and a neck portion (2b) for receiving therein a seal portion (18) of a high-pressure discharge lamp (10), the neck portion (18) protruding rearward from a central portion of the metallic concave reflective portion (2a) and being formed partially of an insulating member (3) or entirely of an insulating material, wherein the metallic concave reflective portion (2a) has a concave reflective surface (2c), at least part of which is formed with an aluminum reflective layer (2h). Forming the aluminum reflective layer (2h) at least part of the concave reflective surface (2c), the reflective layer reflects light by aluminum, while, in case of explosion of the discharge lamp (10), aluminum forming the aluminum reflective layer (2h), together with mercury encapsulated within the discharge lamp (10), produced an amalgam produced thereby preventing mercury from scattering to the outside.

A ninth aspect in accordance with the present invention, the concave reflection mirror is characterized in that a area of the concave reflective surface which has no the aluminum reflective layer covered with a multi-layered deposited film (2d) comprising magnesium fluoride and zinc sulfide. With this arrangement, the multi-layered deposited film (2d) reflects visible rays forwardly, while the metallic concave reflective portion (2a) absorbs infrared rays and radiates heat, which was generated by the infrared rays. Though the aluminum reflective layer (2h) reflects visible rays and infrared rays both, the concave reflection mirror according to this embodiment can suppress forward reflection of infrared rays as compared to a mirror having the concave reflective surface (2c) formed entirely of a total reflection surface that reflects all rays including infrared rays since the aluminum reflective layer (2h) forms part of the concave reflective surface (2c). As described above, the aluminum reflective layer (2h) is capable of capturing mercury by producing an amalgam.

A tenth aspect in accordance with the present invention, the concave reflection mirror is characterized in that the concave reflective portion (2a) has a concave reflective substratum surface (2a1) covered with the heat ray absorptive film (2d1) on which the multi-layered deposited film (2d) is formed as a visible ray reflective film. The heat ray absorptive film (2d1) thus formed behind the multi-layered deposited film (2d) absorbs a considerably large part of infrared rays having passed through the multi-layered deposited film (2d) thereby minimizing the reflected part of infrared rays. As a result, even with the concave reflection mirror (2) using metal for at least the concave reflective portion (2a) thereof, it is possible to avoid an undesired rise in the temperature of the irradiated surface. Heat absorbed by the heat ray absorptive film (2d1) is radiated into the surroundings through the metallic concave reflective portion (2a).

A eleventh aspect in accordance with the present invention, the concave reflection mirror is characterized in that at least the concave reflective portion (2a) comprises iron or stainless steel and the multi-layered deposited film (2d) is formed over a region free of the aluminum reflective layer of the metallic concave reflective substratum surface (2a1) having been subjected to polishing and a subsequent oxidizing treatment. As in the case of the aforementioned embodiment, the resulting black-colored iron oxide film or oxidized stainless steel film is capable of efficiently absorbing infrared rays as an alternative of the heat ray absorptive film which is formed with poor heat absorption efficiency and, hence, the concave reflection mirror is capable of reflecting visible rays only. This embodiment exhibits other effects including: the effect of suppressing heat generation by the lamp; and the effect of shortening the reignition time with respect to equal ignition voltage than the glass reflection mirror by rapid cooling after turning-off of the lamp.

A twelfth aspect in accordance with the present invention, the concave reflection mirror is comprising: a metallic concave reflective portion (2a); and a neck portion (2b) for receiving therein a seal portion (18) of a high-pressure discharge lamp (10), the neck portion (18) protruding rearward from a central portion of the metallic concave reflective portion (2a) and being formed partially of an insulating member (3) or entirely of an insulating material, wherein: at least the metallic concave reflective portion (2a) comprises iron or stainless steel; and a multi-layered deposited film (2d) is formed on a metallic concave reflective substratum surface (2a1) having been subjected to polishing and a subsequent oxidizing treatment. With this arrangement, the multi-layered deposited film (2d) reflects almost of all visible rays forwardly, while the resulting black-colored oxidized layer absorbs most part of infrared rays to suppress forward reflection of infrared rays. Thus, it is possible to suppress a rise in the temperature of the irradiated surface. The absorbed heat is radiated through the metallic concave reflective portion (2a).

A thirteenth aspect in accordance with the present invention, the concave reflection mirror is comprising: a concave reflection mirror (2) as recited in any one of claims 1 to 7 which has a seal portion receiving hole (6a) defined by a neck portion (2b) or an insulating member (3) fitted in the neck portion (2b); and a high-pressure discharge lamp (10) having a seal portion (18) fitted in the seal portion receiving hole (6a) and an opposite seal portion (19), wherein an external lead pin (17) extending outwardly from the opposite seal portion (19) or an auxiliary lead (20) connected to the external lead pin (17) extends through an insulating through-hole or groove (6b) extending along the seal portion receiving hole (6a) defined by the neck portion (2b) or the insulating member (3) fitted in the neck portion (2b), or through an insulating tube (9) inserted through the insulating through-hole or groove (6b).

In the case where the external lead pin (17) or the auxiliary lead (20) connected to the external lead pin (17) extends through the neck portion (2b), the external lead pin (17) or the auxiliary lead (20) is brought close to or into contact with the neck portion (2b) as a metal portion or the concave reflective portion (2a) as a metal portion. Generally, it is considered undesirable according to safety standards that the auxiliary lead (20), even if located on the low voltage side, is brought into contact with or close to a metal portion. With using the insulating tube (9), it is possible to surely insulate the external lead pin (17) or the auxiliary lead (20) connected thereto from a metal portion of the concave reflection mirror (2).

A fourteenth aspect in accordance with the present invention, the light source (1) having a reverse feature as compared with the light source (1) according to claim 13. This embodiment is characterized in that either the external lead pin (17) extending outwardly from the seal portion (19) located on a low voltage side failing to be applied with a high ignition voltage during an ignition phase or the auxiliary lead (20) connected to the external lead pin (17) is electrically connected to the metallic concave reflective portion (2a). In this embodiment, either the external lead pin (17) on the low voltage side or the auxiliary lead (20) connected thereto is intentionally not insulated from but connected to the metallic concave reflection mirror (2). This arrangement allows the metallic concave reflection mirror (2) surrounding the discharge lamp (10) to serve as a shield thereby reducing noise that occurs during the ignition phase.

A fifteenth aspect in accordance with the present invention, the light source is characterized in that the concave reflection mirror (2) has a metal portion having an outer surface covered with an insulating layer (2e). In the case where the external lead pin (17) or the auxiliary lead (20) connected thereto is electrically connected to a metal portion of the concave reflection mirror (2) as in claim 14, the metal portion and the external lead pin (17) are at equal potential and, hence, a safety problem arises that an operator might get an electric shock upon his or her touch with the concave reflection mirror (2). Such a problem can be eliminated by the provision of the insulating layer (2e) covering the outer surface of the metal portion.

A sixteenth aspect in accordance with the present invention, the light source is characterized in that the metallic concave reflective portion (2a) has a front opening provided with a transparent plate (5) The transparent plate (5) closing the front opening is capable of preventing scattering of fragments and diffusion of mercury vapor into the surroundings in case of explosion of the discharge lamp (10). Particularly, the transparent plate (5) cooperates with the aforementioned mercury amalgam producing substance to fixate scattered mercury, thereby contributing to prevention of environmental pollution.

A seventeenth aspect in accordance with the present invention, a discharge lamp lighting circuit (C) is comprising: an ignition circuit section (4) configured to generate a d.c. voltage of 1000 V to 4000 V during a discharge lamp ignition phase; a ballast (6) configured to feed a high-pressure discharge lamp (10) with a lighting power during a steady lighting phase; a high withstand voltage diode (8) having an input side connected to an output line (L) of the ballast (6) and an output side connected to one electrode (12) of the discharge lamp (10), the ignition circuit section (4) having a high d.c. voltage side terminal (47) which is connected to the output side of the high withstand voltage diode (8) so as to have a reverse polarity.

With this circuit (C), the d.c. ignition voltage of 1000 V to 4000 V generated by the ignition circuit section (4) causes dielectric breakdown to occur between the electrodes (12) and (13) of the discharge lamp (10) during the ignition phase, thus allowing glow discharge to occur. At that time, the feature that the high d.c. voltage side terminal (47) of the ignition circuit section (4) is connected to the output side of the high withstand voltage diode (8) prevents the high withstand voltage diode (8) from causing the output voltage of the ignition circuit section (4) to go around toward the ballast (6), thereby allowing the d.c. ignition voltage of 1000 V to 4000 V to be applied across the electrodes (12) and (13). As described earlier in relation to the conventional lighting circuit, application of such an ignition voltage across the electrodes (12) and (13) causes dielectric breakdown to occur between the electrodes (12) and (13), thus allowing the cathode (13) to emit electrons to the anode (12) and forming a narrow discharge path. In this way, discharge starts. Subsequently, as current is fed by application of a proper voltage, the discharge state shifts to arc discharge through glow discharge.

A eighteenth aspect in accordance with the present invention, a light source apparatus (A) is comprising a light source (1) as recited in any one of claims 13 to 15, and a discharge lamp lighting circuit (C).

The present invention thus configured makes it possible to use the concave reflection mirror for discharge lamps, at least the concave reflective portion of which comprises metal and improve the curved surface precision of the concave reflective surface by using metal for the concave reflective portion thereby reducing variations in brightness, allowing the multi-layered deposited film having a relatively low heat-resistant property to be employed, and considerably reducing the required cost. Also, the present invention enables the light source apparatus to be wholly reduced in size and to have a higher integration density. Moreover, the use of the infrared ray absorptive film makes it possible to suppress an undesired rise in the temperature of the irradiated surface as with the glass concave reflection mirror. Other advantages include the effect of minimizing scattering of mercury encapsulated in the discharge lamp to the surroundings in case of explosion of the discharge lamp by appropriately using the mercury amalgam producing material. Particularly where aluminum is used as the mercury amalgam producing material, the use of aluminum is very effective because aluminum serves as a reflective surface under a normal condition while functioning as a mercury capturing agent in case of explosion of the lamp. Further, since the concave reflection mirror is realized using metal, the concave reflection mirror can remain mechanically unbroken even if the high-pressure discharge lamp is exploded.

### BRIEF DESCRIPTION OF DRAWINGS

FIG. 1 is a view showing a lighting circuit according to present invention and a discharge lamp used in combination with the lighting circuit.

FIG. 2 is a view showing a conventional lighting circuit and a discharge lamp used in combination with the conventional lighting circuit.

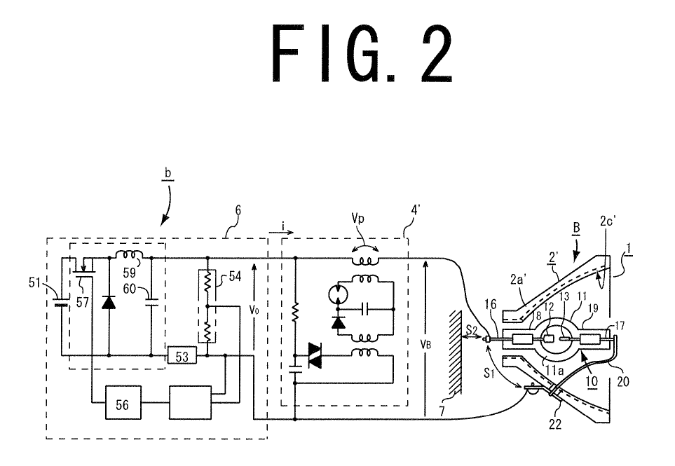

FIG. 3 is a schematic sectional view showing a discharge lamp according to a second embodiment of the present invention.

FIG. 4 is a schematic sectional view showing a discharge lamp according to a third embodiment of the present invention.

FIG. 5 is a schematic sectional view showing a discharge lamp according to a fourth embodiment of the present invention.

FIG. 6 is a sectional view showing a specific example of a discharge lamp according to the present invention.

FIG. 7 is a front view of the discharge lamp shown in FIG. 6.

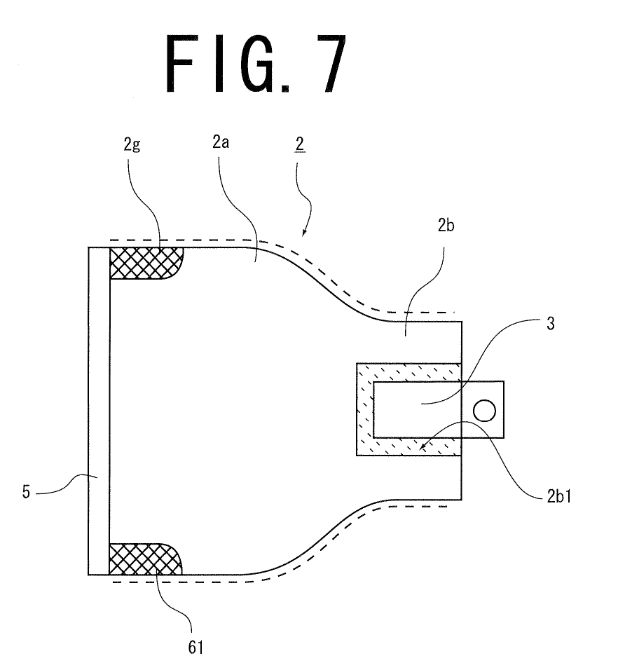

FIG. 8 is a graph plotting an ignition voltage applied by the conventional lighting circuit.

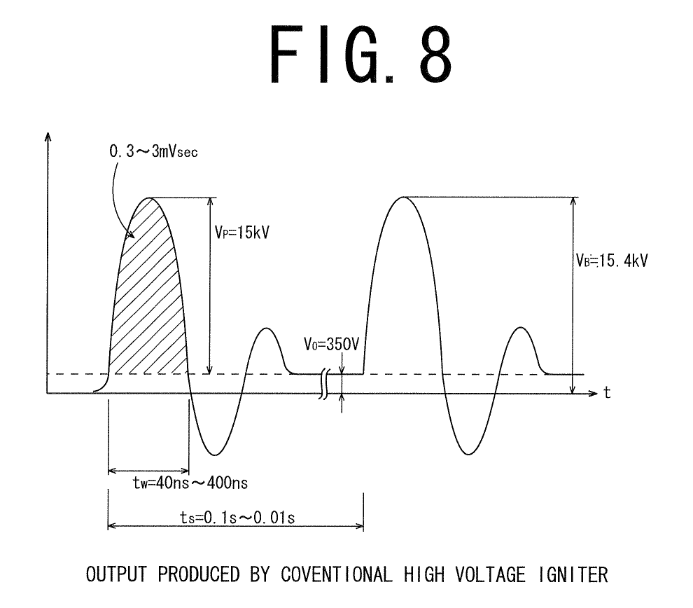

FIG. 9 is a graph plotting an ignition voltage applied by the lighting circuit according to the present invention.

### DESCRIPTION OF REFERENCE CHARACTERS

(1) light source
(2) concave reflection mirror
(2a) concave reflective portion
(2b) neck portion
(3) insulating member
(4) ignition circuit section
(5) transparent plate
(8) diode for lighting
(9) discharge lamp
(10) mesh plate

### BEST MODE FOR CARRYING OUT THE INVENTION

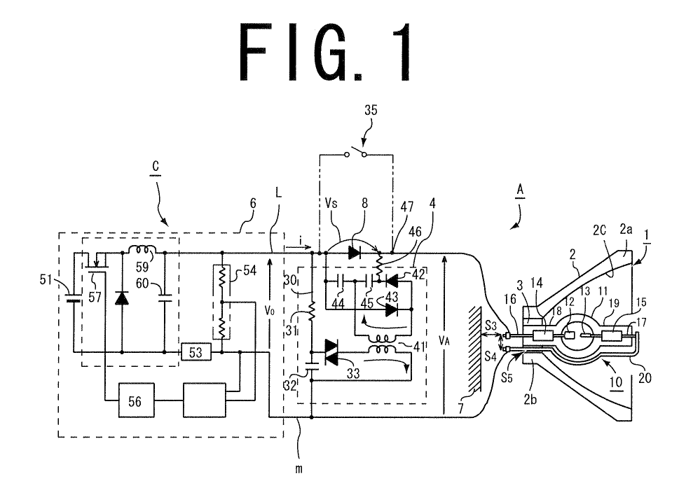

Hereinafter, preferred embodiments of the present invention will be described. FIG. 1 shows a light source (1) including a double-ended high-pressure discharge lamp (10) fitted with a concave reflection mirror (2) using metal for at least a concave reflective portion (2a) thereof, and a lighting circuit (C) associated therewith. This embodiment is a representative of arrangements of the type in which the high-pressure discharge lamp (10) fitted with the concave reflection mirror (2) has a seal portion (18) located on a high voltage side to be applied with a high voltage during an ignition phase as described earlier. The double-ended discharge lamp (10) is described herein as a representative of high-pressure discharge lamps. Besides, a single-ended discharge lamp may be used.

The high-pressure discharge lamp (10) used in the present invention has an envelope (11) formed from quartz glass, which is substantially insusceptible to thermal expansion/contraction. The envelope (11) comprises a hollow spherical arc tube portion (11a) and seal portions (18) and (19) extending straight from opposite ends of the arc tube portion (11a). Molybdenum foils (14) and (15) are air-tightly embedded within the seal portions (18) and (19), respectively, by means of shrink seal. Each of the molybdenum foils (14) and (15) has one end welded to a root portion of a respective one of the electrodes (12) and (13) and an opposite end welded to an embedded end of a respective one of external lead pins (16) and (17). The other end of each of the external lead pins (16) and (17) is led to the outside. The leading ends of the respective electrodes (12) and (13) are opposed to each other with a predetermined spacing (0.8 to 1.5 mm).

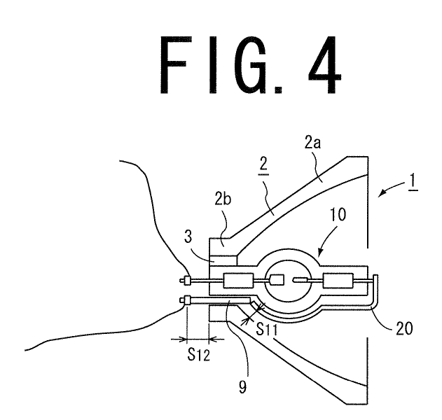

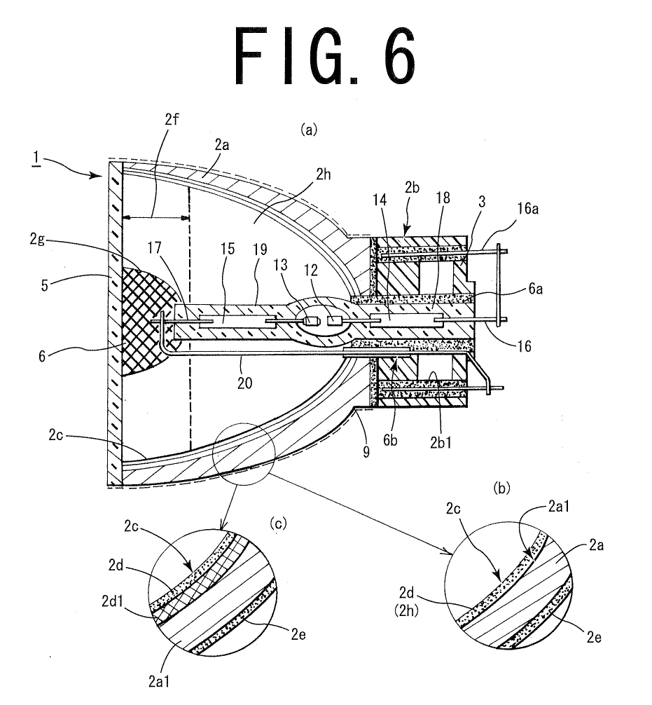

The high voltage side external lead pin (16) is connected to a plus side output line (L) of an ignition circuit section (S) of the lighting circuit (C) via a terminal (16a). The low voltage side external lead pin (17) is connected to an auxiliary lead (20) extending along the high-pressure discharge lamp (1). In the embodiment shown in FIGS. 1, 4 and 6 (here, description is made particularly of FIG. 6 showing the discharge lamp of FIGS. 1 and 4 in detail), the auxiliary lead (20) is led out of the concave reflection mirror (2) rearward through an insulating through-hole (6b) defined through an insulating member (3) which is provided inside a neck portion (2b) to fix the high voltage side seal portion (18) of the high-pressure discharge lamp (1). (The auxiliary lead (20) functions as an exvoltage lead of the low voltage side external lead pin (17) and hence is equivalent to the low voltage side external lead pin (17).) (The insulating through-hole (6b) may be in the form of a groove instead of a hole, or the auxiliary lead (20) may merely extend through a high voltage side seal portion receiving hole (6a).) A terminal (16a) is provided at a led-out end of the auxiliary lead (20) and is connected to a low voltage side line (m) of the ignition circuit section (4).

A metal is used for at least the concave reflective portion (2a) of the concave reflection mirror (2). (Such a metal is a metal material having a thermal conductivity of not less than 50 W/m·K, the higher the more preferable, for example, a die-cast aluminum in the present embodiment). The concave reflective portion (2a) of the concave reflection mirror (2) is shaped appropriately into an ellipsoidal surface of revolution, a paraboloid of revolution, a hemispherical surface, or the like to meet the nature of required light. The concave reflective portion (2a) has a concave reflective surface (2c) formed with a multi-layered deposited film (2d). The multi-layered deposited film (2d) used as a visible ray reflective film of the concave reflective portion (2a) may comprise, for example, magnesium fluoride (MgF₂) and zinc sulfide (ZnS). When necessary, an infrared ray absorptive layer (2d1) may be provided between the multi-layered deposited film (2d) and a substratum (2a1) of the concave reflective portion (2a). The infrared-ray absorptive layer (2d1) comprises a heat-resistant black paint.

Though the concave reflection mirror (2) may be formed entirely of metal, it is possible to employ such a construction that the concave reflective portion (2a) formed of metal is joined with the neck portion (2b) formed of an insulating material or that the neck portion (2b) formed of metal defines a concave groove (2b1) receiving the insulating member (3) fixed thereto by means of an insulating inorganic adhesive made from the same material as the insulating member (3). In this embodiment, the construction shown in FIG. 6 is described as a representative of such constructions. The metal used for the concave reflection mirror (2) is preferably a metal having an excellent thermal conductivity. Die-cast aluminum is most preferable in view of its various features including weight, cost, workability and mechanical strength.

The insulating member (3), which is fitted in the neck portion (2b) of the concave reflection mirror (2) as described above, is formed from a ceramic and centrally defines the seal portion receiving hole (6a) for receiving the high voltage side seal portion (18) of the high-pressure discharge lamp (1) therein. In the embodiment shown in FIG. 1, the seal portion receiving hole (6a) has an inner periphery formed with a concave insulating groove (6b). Though not shown, an insulating hole (6a) extending along the seal receiving hole (6a) may be provided.

The multi-layered deposited film (2d) comprising magnesium fluoride (MgF₂) and zinc sulfide (ZnS), which serves as the visible ray reflective film forming the concave reflective surface (2c), is deposited on the concave reflective surface (2c). Further, the infrared ray absorptive film (2d1) is formed between the multi-layered deposited film (2d) and the substratum surface (2a1) of the concave reflective portion (2a) when necessary.

On the other hand, the following structure is acceptable as a structure free of the infrared ray absorptive film (2d1) as shown in FIG. 6(b). This structure is formed through a process including: using iron or stainless steel for at least the concave reflective portion (2a) of the concave reflection mirror (2); mirror-polishing the metallic concave reflective substratum surface (2a1); subjecting the metallic substratum surface (2a1) to an oxidizing treatment (so-called blackening treatment); and forming the multi-layered deposited film (2d) on the metallic substratum surface (2a1). That is, the multi-layered deposited film (2d) is formed directly on the blackened metallic substratum surface (2a1) (comprising a very thin heat-resistant oxide film) resulting from the oxidizing treatment.

The blackened oxide film absorbs infrared rays, while the concave reflection portion (2a) of iron radiates heat efficiently. On the other hand, the visible ray reflective film (multi-layered deposited film (2d)) forming the concave reflective surface (2c) reflects visible rays efficiently. This method has an advantage that the aforementioned heat ray absorptive film (2d1) which is formed with poor precision can be unnecessary. Moreover, the reflection mirror (2) comprising metal (iron in the present embodiment) suppresses an undesired rise in the temperature of the discharge lamp (10) by conduction of heat generated by infrared rays absorbed. After turning-off of the lamp, in particular, the metallic concave reflection mirror (2) according to this embodiment exhibits a higher cooling rate than the conventional glass reflection mirror and, therefore, the reignition time is shortened with respect to equal ignition voltage.

Possible arrangements include: an arrangement wherein the concave reflective surface (2c) defines a front opening which is left open without provision of a transparent plate (5) for closing the front opening and an opening portion (2f) of the concave reflective surface (2c) within a range of about 5 to 10 mm from the open end is plated with a mercury amalgam producing substance, such as zinc, tin or silver, which is capable of producing an amalgam when combined with mercury; and an arrangement wherein the front opening of the concave reflective portion (2a) is closed with the transparent plate (5) and the peripheral edge portion of the concave reflective portion (2a) defining the front opening is formed with a notch or cut-out portion (2g) fitted with a mesh plate (61) which is plated with or formed of the mercury amalgam producing substance, such as zinc, tin or silver, which is capable of producing an amalgam when combined with mercury. Examples of such mesh plates include porous plate, punching metal, and net. Such a mesh plate (61) may be used in combination of plating of the opening portion (2f) with the mercury amalgam producing substance.

Another example of the mercury amalgam producing substance is aluminum used as a reflective layer (2h). In this case, the concave reflective surface (2c) is entirely or partially covered with the aluminum reflective layer (2h). With the concave reflective surface (2c) entirely or partially covered with the aluminum reflective layer (2h), the aluminum reflective layer (2h) acts as a capturing agent for capturing mercury encapsulated in the lamp upon explosion of the lamp, though both infrared rays and visible rays are reflected forwardly. Thus, this arrangement is preferable since the aluminum reflective layer (2d) is capable of preventing mercury from scattering to the outside.

The aluminum reflective layer (2h) need not necessarily be formed over the entire concave reflective surface (2c). It is possible that the aluminum reflective layer (2h) is formed to cover part of the concave reflective surface (2c), for example, a central portion of the concave reflective surface (2c) that surrounds the neck portion (2b) (this central portion is most reflective with respect to light from the lamp) and the multi-layered deposited film (2d) formed to cover the rest. With such an arrangement, visible rays are reflected forwardly by the multi-layered deposited film (2d), while infrared rays are absorbed toward the metallic concave reflective portion (2a) and radiated as heat. Though the aluminum reflective layer (2h) reflects both visible rays and infrared rays forwardly, this arrangement is capable of reducing the amount of infrared rays to be reflected forwardly as compared with an arrangement having the concave reflective surface (2c) entirely formed as a total reflection surface with respect to all rays including infrared rays. The portion over which the aluminum reflective layer (2h) is formed is not limited to the central portion of the concave reflective surface (2c) that surrounds the neck portion (2b). The aluminum reflective layer (2d) may be formed on the opening portion (2f) or any portion other than the central portion.

In the case described above, the multi-layered deposited film (2d) may be formed on the heat ray absorptive film (2d1) which is formed over the concave reflective substratum surface (2a1). The heat ray absorptive film (2d1) provided behind the multi-layered deposited film (2d) absorbs a considerably large part of infrared rays having passed through the multi-layered deposited film (2d) as described above, thereby minimizing the reflected part of infrared rays. As a result, even with the concave reflection mirror (2) using metal for at least the concave reflective portion (2a) thereof, it is possible to avoid an undesired rise in the temperature of the irradiated surface. Heat absorbed by the heat ray absorptive film (2d1) is radiated into the surroundings through the metallic concave reflective portion (2a).

Use of iron or stainless steel for the concave reflective portion (2a) makes it possible to form a black-colored oxide film or oxidized stainless steel film having a higher precision instead of the heat ray absorptive film (2d1). Specifically, at least the concave reflective portion (2a) comprises iron or stainless steel and the multi-layered deposited film (2d) is formed on the metallic concave reflective substratum surface (2a1) having been subjected to polishing and a subsequent oxidizing treatment. Alternatively, it is possible to form the aluminum reflective layer (2h) over a required region as well as the heat ray absorptive film (2d1) over a region free of the aluminum reflective layer (2d1). Instead of the heat ray absorptive film with a poor precision, the resulting blackened iron oxide film or oxidized stainless steel film is capable of efficiently absorbing infrared rays and, hence, the concave reflection mirror (2) is capable of reflecting visible rays only. This arrangement exhibits other effects including: the effect of suppressing heat generation of the lamp; and the effect of making shorter the reignition time with respect to equal ignition voltage than the glass reflection mirror by rapid cooling after turning-off of the lamp.

In the case of FIG. 6, the high-pressure discharge lamp (10) has its high voltage side seal portion (18) inserted in the aforementioned seal portion receiving hole (6a) and fixed thereto by means of an inorganic adhesive. On the other side, the external lead pin (17) led out of the low voltage side seal portion (18) is connected to the auxiliary lead (20) led out rearward of the concave reflection mirror (2) through an insulating tube (9) fitted in the insulating groove (6b) defined in the inner periphery of the seal portion receiving hole (6a) The insulating tube (9) prevents the auxiliary lead (20) from contacting the concave reflective portion (2a), which is made of metal.

The lighting circuit (C) comprises a ballast (6), ignition circuit section (4) and high voltage proof diode (8). In this lighting circuit (C), the ballast (6) is adapted to direct current and connected to the high-pressure discharge lamp (10) via the high voltage proof diode (8). In the case of alternate current, a relay (35) is connected in parallel with the high voltage proof diode (8), as shown by a dashed double-dotted line.

The ballast (6) comprises: a d.c. power source (51) represented by a symbol of a cell, which usually rectifies commercial current into direct current by means of a rectifier; a pulse width control circuit (56) operative to sense the lighting current to the discharge lamp (10) and control a pulse width; a switching device (57) operative to perform a switching operation in response to a pulse width control signal transmitted from the pulse width control circuit (56); a choking coil (59) connected in series with the switching device (57); a smoothing capacitor (60) provided between the plus side output line (L) and the low voltage side line (m) for smoothing a current having a controlled pulse width fed from the switching device (57) cooperatively with the choking coil (59); and a sensing resistor (53) provided on the low voltage side line (m) for sensing the lamp current. The ballast (6) is configured to feed the discharge lamp (10) with a power required for lighting during a steady lighting phase.

In the present embodiment, the high voltage proof diode (8) is connected to the plus side output of the ballast (6). During the steady lighting phase, the output of the ballast (6) is fed to the high-pressure discharge lamp (10) through the high voltage proof diode (8) thereby lighting the high-pressure discharge lamp (10) steadily.

The ignition circuit section (4) configured to output a high d.c. voltage of about 1000 V to about 4000 V (with a small current capacity as low as about 0.1 mA to about 1.0 mA) is generally known in the art. Here, one such ignition circuit section (4) is described. A resistor (31) and an ignition pulse generating capacitor (32) are connected in series with a branch line (30) branched from the plus side output line (L) of the ballast (6). The opposite terminal of the ignition pulse generating capacitor (32) is connected to the low voltage side line (m). A trigger device (33) has one terminal connected to the node between the resistor (31) and the ignition pulse generating capacitor (32) and an opposite terminal connected to the primary coil of a booster transformer (41). The opposite end of the primary coil of the booster transformer (41) is connected to the low voltage side line (m) of the ballast (6) in such a manner as to straddle the ignition pulse generating capacitor (32).

The secondary coil of the booster transformer (41) has one end connected to the node between a pair of voltage boosting capacitors (44) and (45) connected in series and an opposite end connected to one voltage boosting capacitor (45) via a diode (42). Another diode (43) as a counterpart of the diode (42) is located between the node interconnecting the plus side output line (L) and the voltage boosting capacitor (44) and the node interconnecting the diode (42) and the secondary coil. A protective resistor (46) is connected between the node interconnecting the voltage boosting capacitor (45) and the diode (42) and the output side of the high voltage proof diode (8) on the plus side output line (L).

The following description is directed to the operation of the lighting circuit (C) shown in FIG. 1. When the switch (not shown) of an optical apparatus is turn on, the optical apparatus is actuated to ignite the lamp. The igniting operation proceeds as follows. When the discharge lamp (1) is in a state before lighting, a d.c. output produced from the d.c. ballast (6) passes through the plus side output line (L) and then the branch line (3) to actuate the ignition circuit section (4). The ignition circuit section (4) operates as follows. Current passing through the branch line (30) flows to the pulse generating capacitor (32) through the resistor (31) to charge the pulse generating capacitor (32), thus resulting in a voltage across the opposite terminals of the capacitor (32). When this voltage reaches a predetermined trigger voltage (about 200 V for example) for the trigger device (33), the trigger device (33) connected in parallel with the pulse generating capacitor (32) is actuated to pass a trigger current thereby producing a pulse voltage waving between the plus side and the minus side on the primary side of the booster transformer (41). The pulse voltage thus produced causes the secondary side of the booster transformer (41) to produce a boosted pulse voltage waving between the plus side and the minus side in an amplified fashion. The boosted pulse voltage causes a current to flow in the direction indicated by arrow on the secondary side to the capacitor (44) through the diode (43), thereby charging the capacitor (44). On the other hand, a current flowing in the direction opposite to the direction of arrow reaches the capacitor (45) through the diode (42), thereby charging the capacitor (45). The charging of the capacitors is achieved in an instant upon generation of waving voltages in response to actuation of the trigger device (33). In this way, the output voltage Vs of the ignition circuit section (4) is produced across the opposite ends of the capacitors (44) and (45) connected in series.

The voltage produced across the opposite ends of the series-connected capacitors (44) and (45) serves as a voltage (Vs) to be applied across the opposite terminals of the high voltage proof diode (8) through the resistor (46). In this case, the output side of the high voltage proof diode (8) for lighting is at a higher voltage. At that time, the resistor (46), which serves as a protective resistor for the diodes (42) and (43) as will be described later, produces little voltage, or a negligible voltage and, hence, the voltage produced across the opposite ends of the capacitors (44) and (45) is substantially equal to the voltage (Vs) across the high voltage proof diode (8) for lighting. The high withstand voltage diode (8) feeds the high-pressure discharge lamp (10) with the output produced from the ignition circuit section (4) thereby preventing the output from applying to the ballast (6).

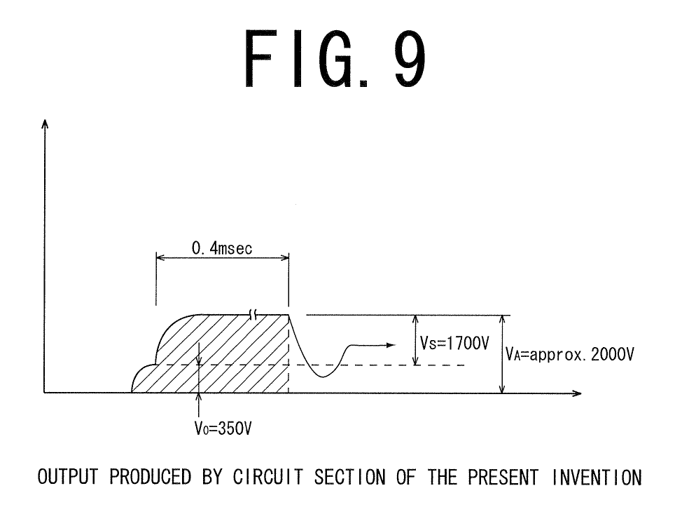

During the lamp ignition phase (during which the high-pressure discharge lamp (10) does not light yet), on the other hand, a voltage (Vo), which is produced between the plus side output line (L) of the ballast (6) and the low voltage side line (m), raises the ignition voltage (VA)=(Vo)+(Vs) to be applied across the electrodes (12) and (13) of the discharge lamp (10) as the boosted output capacitors (44) and (45) are charged, and then the ignition voltage (VA) is continuously applied. FIG. 9 is a graph plotting this relationship (wherein the ordinate and the abscissa represent voltage and time, respectively). The relationship plotted here is a typical example wherein Vo=350 V, Vs=1700 V, and VA=about 2000 V.

The energy required for dielectric breakdown of the high-pressure discharge lamp (10) is an energy expressed by the product of voltage by time. (Note that the dielectric breakdown energy increases exponentially with lowering voltage.) Even if the voltage is lower than the conventionally used voltage, the required dielectric breakdown energy is reached by continuous application of the voltage for a certain time period, thus causing arc discharge to occur between the electrodes (12) and (13). For example, if the ignition voltage (VA) is about 2000 V, the dielectric breakdown energy is reached by application of the ignition voltage for about 0.4 ms.

After the lamp has been ignited, the discharge state shifts from glow discharge to arc discharge smoothly, so that the lighting state of the lamp shifts to the steady lighting state. The lamp voltage steeply drops during an initial arc discharge stage just after the shifting from the glow discharge state and then gradually rises to a predetermined voltage (80 V for example). Thereafter, this voltage is maintained for steady lighting. Since the output voltage (lamp voltage) of the ballast (6) is kept lower than the trigger voltage of the trigger device (33) during the steady lighting phase as described above, the charging voltage for the pulse generating capacitor (32) is lower than the trigger voltage of the trigger device (33), thus causing the trigger device (33) to stop operating. Accordingly, the booster transformer (41) also stops operating, thus allowing a steady lamp current to be fed to the high-pressure discharge lamp (10) through the high voltage proof diode (8) during the steady lighting phase.

During steady lighting, current outputted from the d.c. ballast (6) passes through the discharge lamp (10) and then the low voltage side line (m) to cause the sensing resistor (53) to produce a voltage. The pulse width control circuit (56) senses the voltage produced by the sensing resistor (53) to check the lighting current passing through the discharge lamp (10) and performs switching control over the switching device (57) so that the power fed to the discharge lamp (10) is held constant.

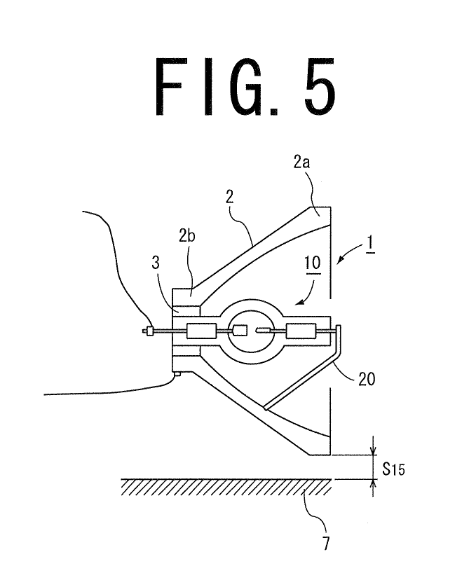

In the above-described operation, it is conceivable that discharge between the electrodes (12) and (13) during the ignition phase generates noise affecting the peripheral circuits. If the auxiliary lead (20) connected to the low voltage side external lead pin (17) is connected to the metallic concave reflective portion (2a) as shown in FIG. 5, the concave reflective portion (2a) serves as a shielding member against such noise, thereby reducing occurrences of malfunction of the peripheral circuits. (Of course, a typical of such arrangements is the aforementioned arrangement wherein the high voltage side seal portion (18) of the discharge lamp (10) is fitted in the neck portion of the concave reflection mirror (2) while the external lead pin (17) extending from the low voltage side seal portion (19) or the auxiliary lead (20) connected thereto is electrically connected to the concave reflective portion (2a) forming a metal portion of the concave reflection mirror (2).)

Though this arrangement can be expected to exercise the shielding effect as described above, the concave reflective portion (2a) and the external lead pin (16) or (17) are at the same potential and, therefore, an operator handling the light source apparatus (A) might get an electric shock when touching the concave reflective portion (2a) inadvertently. Such a danger can be reliably avoided if the outer surface of the concave reflective portion (2a) forming a metal portion of the concave reflection mirror (2) or the outer surface of the entire concave reflection mirror (2) is coated with an insulating layer (2e).

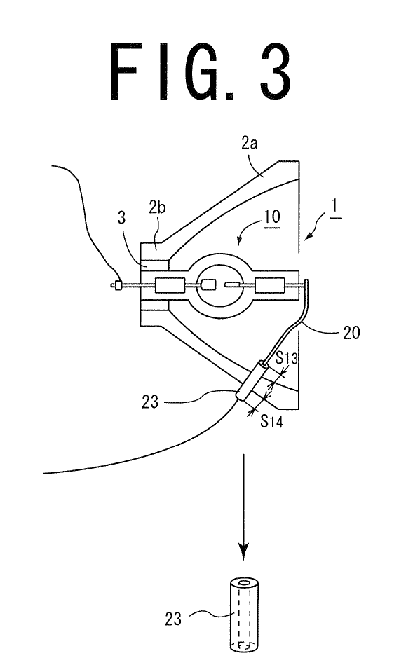

In the case where the auxiliary lead (20) extending through the concave reflective portion (2a) need be insulated from the concave reflective portion (2a) as shown in FIG. 3, an insulating tube (23) inserted through the concave reflective portion (2a) is utilized. FIG. 4 is a schematic view of the arrangement shown in FIG. 6 wherein the auxiliary lead (20) extends through the neck portion (2b). In FIG. 4, an insulation distance (S11) between the metallic concave reflective portion (2a) and the auxiliary lead (20) and an insulation distance (S12) between the exposed end of the auxiliary lead (20) extending through the insulating tube (9) and the metallic neck portion (2b) are indicated. In the case of the present invention, each insulation distance ranges from about 2 to about 6 mm in accordance with the d.c. voltage of 1 to 4 kV used. FIG. 5 is a view showing an arrangement having the auxiliary lead (2) connected to the concave reflective portion (2a) having an outer surface uncoated with the insulating layer (2e). In this arrangement, an insulation distance (S15) between the metallic concave reflective portion (2a) and a metal portion (7) of the lamp house needs to be the same distance as noted above or a distance prescribed by safety standards. The insulation distance (S15) can be rendered shorter if the outer surface of the concave reflective portion (2a) is coated with the insulating layer (2e).

During the steady lighting phase of the high-pressure discharge lamp (10), part of light outgoing from the high-pressure discharge lamp (10) is emitted directly forwardly, while the rest of light reflected by the concave reflective portion (2a). Light emitted forwardly passes through an optical system including, for example, a UV-IR cut filter, a dichroic mirror for color separation, a total reflection mirror, and like components, then passes through a projection lens (70) and is projected as a color image on a screen (S) located in front.

If the infrared ray absorptive film (2d1) or the blackened iron oxide film or oxidized stainless steel film underlies the multi-layered deposited film (2d), only visible rays are reflected by the multi-layered deposited film (2d), while infrared rays absorbed by the infrared ray absorptive film (2d1) or the blackened iron oxide film or oxidized stainless steel film without forward reflection. The infrared rays thus absorbed heats the concave reflection mirror (2) and heat thus generated is dissipated through the concave reflection mirror (2) into the surroundings. As a result, a rise in the temperature of the irradiated surface is suppressed in spite of the use of the high-pressure discharge lamp (10) as a light source.

Since the arc tube portion (11a) of the high-pressure discharge lamp (10) is filled with required gases, mercury and the like, the high-pressure discharge lamp (10) itself is heated to an elevated temperature and the atmospheric pressure within the arc tube portion (11a) raised to a very high atmospheric pressure, for example, about 150 atm during lighting of the high-pressure discharge lamp (10). The envelope (11), which is formed from glass, might explode because of such a very high atmospheric pressure. In such a case, mercury encapsulated within the arc tube portion (11a) is evaporated and scattered around, thereby contaminating the surroundings.

In order to avoid such an inconvenience, the mercury amalgam producing material, which is capable of producing an amalgam when combined with mercury, is used for the mesh plate (61) extending over the opening portion (2f) as a dead zone or over the cut-out portion (2g). (Alternatively, the aluminum reflective layer (2h) is formed over a required portion by vapor deposition.) If so, mercury vapor is chemically combined with the mercury amalgam producing material when contacting those portions, deposited on such portions and remains thereon. As a result, the amount of scattering of mercury can be reduced.

In the case where the front opening is closed with the transparent plate (5) and the cut-out portion (2g) not provided, mercury as well as glass fragments remains within the concave reflective portion (2a) even in case of explosion unless the transparent plate (5) is broken. Thus, a considerable amount of mercury is captured to form the amalgam.

Alternatively, in the case where the cut-out portion (2g) is formed in the opening portion (2f) of the concave reflective portion (2f) (with the front opening closed with the transparent plate (5)) and the mesh plate (61) extends over the cut-out portion (2g) to utilize the cut-out portion (2g) as a vent for cooling, mercury vapor produced upon explosion of the discharge lamp (10) is captured by the mercury amalgam producing substance of the mesh plate (61) when passing through the mesh plate (6) toward the outside, whereby it is possible to suppress flow of mercury to the outside. In this case, if the mercury amalgam producing substance is additionally provided on the opening portion (2f), residual mercury remaining within the concave reflective portion (2a) can be captured effectively.

The light source (1) may include a single-ended discharge lamp (10′) fitted with the concave reflection mirror (2) as shown in FIG. 1 instead of the double-ended discharge lamp (10) fitted with the concave reflection mirror (2).

A light source for use in a large-screen rear projection television or a liquid crystal projector is requested to provide uniform brightness over the entire screen. The use of the metallic reflector makes it possible to improve the surface precision of the reflective surface remarkably as well as to reduce the required cost as compared to the use of a glass reflector. Also, the metallic reflector is highly resistant to explosion of the lamp and the like and hence can enhance the strength of the light source. The light source according to the present invention is indispensable particularly as a light source for future large-screen rear projection televisions.

1. A concave reflection mirror comprising: a metallic concave reflective portion; and a neck portion for receiving therein a seal portion of a high-pressure discharge lamp to be continuously applied a d.c. voltage of 1000 V to 4000 V during an ignition phase, the neck portion protruding rearward from a central portion of the metallic concave reflective portion and being formed partially of an insulating member or entirely of an insulating material.

2. A concave reflection mirror comprising: a metallic concave reflective portion; and a neck portion for receiving therein a seal portion of a high-pressure discharge lamp, the neck portion protruding rearward from a central portion of the metallic concave reflective portion and being formed partially of an insulating member or entirely of an insulating material, wherein the metallic concave reflective portion has a concave reflective surface with an opening portion provides an amalgam producing substance which is combined with mercury.

3. The concave reflection mirror according to claim 2, wherein the opening portion of the metallic concave reflective portion has a cut-out portion over which a mesh plate formed from the amalgam producing substance or bearing the amalgam producing substance deposited thereon extends.

4. The concave reflection mirror according to claim 1, wherein the metallic concave reflective portion has a metal portion having a thermal conductivity of not less than 50 W/m-K.

5. The concave reflection mirror according to claim 1, wherein the concave reflective surface of the concave reflective portion is formed with a multi-layered deposited film comprising magnesium fluoride and zinc sulfide.

6. The concave reflection mirror according to claim 1, wherein the concave reflective portion has a concave reflective substratum surface covered with a heat ray absorptive film on which a multi-layered deposited film is formed as a visible ray reflective film.

7. The concave reflection mirror according to claim 1, wherein at least the concave reflective portion comprises iron or stainless steel and a multi-layered deposited film is formed on a metallic concave reflective substratum surface having been subjected to polishing and a subsequent oxidizing treatment.

8. A concave reflection mirror comprising: a metallic concave reflective portion; and a neck portion for receiving therein a seal portion of a high-pressure discharge lamp, the neck portion protruding rearward from a central portion of the metallic concave reflective portion and being formed partially of an insulating member or entirely of an insulating material, wherein the metallic concave reflective portion has a concave reflective surface, at least part of which is formed with an aluminum reflective layer.

9. The concave reflection mirror according to claim 8, wherein a area of the concave reflective surface, which does not include the aluminum reflector layer, covered with a multi-layered deposited film comprising magnesium fluoride and zinc sulfide.

10. The concave reflection mirror according to claim 8, wherein the concave reflective portion has a concave reflective substratum surface covered with a heat ray absorptive film on which the multi-layered deposited film is formed as a visible ray reflective film.

11. The concave reflection mirror according to claim 8, wherein at least the concave reflective portion comprises iron or stainless steel and the multi-layered deposited film is formed over a region free of the aluminum reflective layer of a metallic concave reflective substratum surface having been subjected to polishing and a subsequent oxidizing treatment.

12-18. (canceled)

19. The concave reflection mirror according to claims 2, wherein the metallic concave reflective portion has a metal portion having a thermal conductivity of not less than 50 W/m K.

20. The concave reflection mirror according to claims 2, wherein the concave reflective surface of the concave reflective portion is formed with a multi-layered deposited film comprising magnesium fluoride and zinc sulfide.

21. The concave reflection mirror according to claims 2, wherein the concave reflective portion has a concave reflective substratum surface covered with a heat ray absorptive film on which a multi-layered deposited film is formed as a visible ray reflective film.

22. The concave reflection mirror according to claims 2, wherein at least the concave reflective portion comprises iron or stainless steel and a multi-layered deposited film is formed on a metallic concave reflective substratum surface having been subjected to polishing and a subsequent oxidizing treatment.
